(19) United States
(12) Patent Application Publication
(10) Pub. No.: US 2004/0190571 A1
(43) Pub. Date: Sep. 30, 2004

(54) Wavelength stabilised laser source

(76) Inventors: Stephen Sutton, Dorset (GB); Nigel Keith Hedges, Dorset (GB); Rainer Strzoda, Munich (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/469,796

(22) PCT Filed: Feb. 27, 2002
(86) PCT No.: PCT/GB02/00870

(30) Foreign Application Priority Data
Mar. 8, 2001 (GB) 0105651.4
Oct. 11, 2001 (GB) 0124426.8

(51) Int. Cl. H01S 3/13; H01S 3/04

(52) U.S. Cl. 372/36; 372/32

(57) ABSTRACT

There is provided an integrated wavelength-stabilised laser source comprising: a laser diode; a temperature-stabilising heat pump in thermal communication with the laser diode; and at least one detector, encapsulated within a hermetically sealed package comprising a window for passing light from the laser diode to the exterior of the package.

The present invention relates to laser or light sources, in particular, laser sources of stabilised wavelength.

Throughout this document, the control of wavelengths will be discussed. In this context, use of the term ‘wavelength’ assumes a known transmission medium, in accordance with standard terminology in the art. Furthermore, the invention will be described with reference to laser light produced by a laser diode. The invention may, however, be applied in a corresponding fashion to other light sources.

Many applications require a laser or light source providing a stabilised wavelength. An example is a gas detection instrument, in which a laser or light source must be provided, and controlled to provide a stable wavelength, corresponding to an absorption line of the spectrum of the gas to be detected. If the provided light is absorbed, the gas is deemed to be present to an extent commensurate with the proportion of light absorbed. If the provided light is not absorbed, the gas is deemed not to be present. Various levels of absorption may be correlated to various densities of target gas and optical path lengths therein.

The present invention will be particularly described with reference to gas detection instruments, although the present invention is also applicable to other applications of stabilised wavelength light or laser sources, including applications in the telecommunications industry where precise tuning to specific communications wavelengths is important. For example, wavelength references for optical test equipment such as spectrum analysers, optical transmission/receiver systems or wavelength calibration of lasers used in Dense Wavelength Division Multiplexing (DWDM) systems.

While gas detection instruments including a wavelength-stabilised laser diode referenced to a specific spectral absorption line of the target gas exist, they suffer from a number of problems. Difficulties are encountered in achieving a reliable wavelength stability. Some known systems address this difficulty by providing temperature control of the laser diode. Providing temperature stability to the laser diode allows the laser diode to achieve a desired wavelength stability. However, the temperature controlling of the laser diode, particularly in the sense of cooling the diode, is known to create problems such as condensation of water vapour from the atmosphere onto the laser diode and the associated temperature and control means.

It is therefore an object of the present invention to provide a light or laser source of stabilised wavelength. It is a further object of the present invention to provide such a source which is substantially immune to problems arising from condensation of moisture. It is a further object of the present invention to provide an integrated gas detection device, comprising a light or laser source, wavelength stabilising means and a light or laser detector, which provides light of stabilised wavelength and is substantially immune to difficulties arising from condensation of moisture.

Accordingly, the present invention provides an integrated wavelength-stabilised laser source comprising: a laser diode; a temperature-stabilising heat pump in thermal communication with the laser diode; and at least one detector, encapsulated within a hermetically sealed package comprising a window for passing light from the laser diode to the exterior of the package.

The heat pump may be operable to adjust the operating temperature of the laser diode, thereby adjusting the wavelength of light emitted by the laser diode.

The source may further comprise a temperature sensor arranged to provide primary control of the operation of the heat pump.

The at least one detector comprises a monitor detector, positioned to receive a portion of laser light emitted by the laser diode.

A surface of the window may be arranged to reflect the portion of light emitted by the laser diode to the monitor detector.

The monitor detector may be arranged to provide a control signal for controlling the wavelength of light produced by the laser diode.

The hermetically sealed package may contain a gas sample, said gas having an absorption line for use by the monitor detector for measuring the wavelength of light emitted by the laser diode. In this case, the interior of the hermetically sealed package may be substantially filled with a gas sample.

The monitor detector may comprise a light sensor exposed to the interior of the hermetically sealed package. Alternatively, the monitor detector may comprise a light sensor and a gas sample, enclosed within an enclosure.

Secondary control of the heat pump is preferably provided, in accordance with an output of the monitor detector.

The control signal from the monitor detector may be arranged to control the operation of the heat pump, thereby adjusting the wavelength of light emitted by the laser diode by adjusting the operating temperature of the laser diode. Alternatively, or in addition, the control signal from the monitor detector may be arranged to control a level of an operating current supplied to the laser diode, thereby adjusting the wavelength of light emitted by the laser diode.

The at least one detector may comprise a signal detector arranged to monitor incident light entering the package through the window.

The present invention also provides a gas monitor product incorporating a source according to the invention. In such as gas monitor product, the gas sample may correspond to a gas to be monitored by the gas monitor product, but this is not necessarily the case.

In a gas monitor product according to the invention, laser light may be emitted from the source to follow an optical path through a monitored gas, said optical path returning through the window to the signal detector, whereby absorption of the laser light may be evaluated in order to monitor the composition of the monitored gas.

The present invention also provides a wavelength reference device comprising a source as described.

The above, and further, objects, characteristics and advantages of the present invention will become more apparent with reference to the following description of certain embodiments of the present invention, given by way of examples only, along with the accompanying drawings, in which:

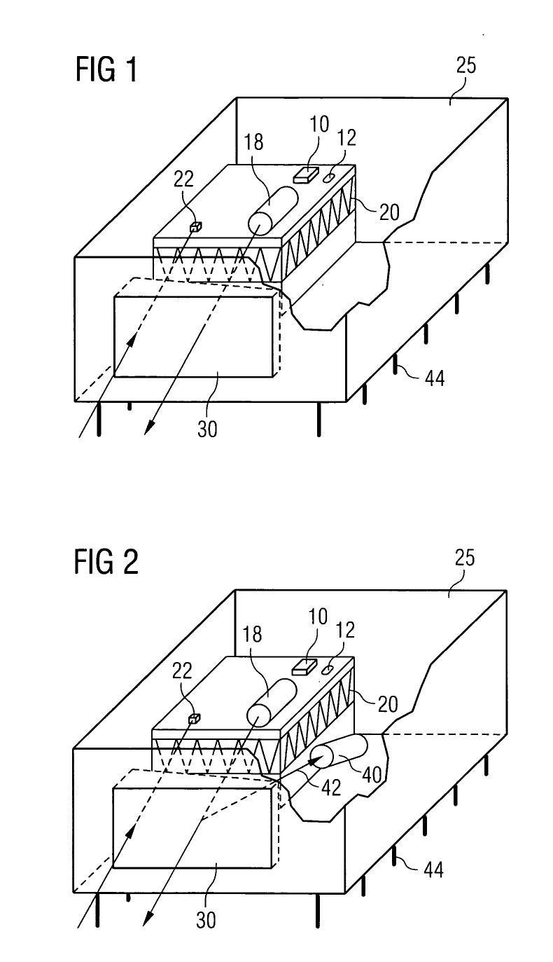

FIG. 1 shows a laser or light source according to an embodiment of the present invention;

FIG. 2 shows a laser or light source according to another embodiment of the present invention; and

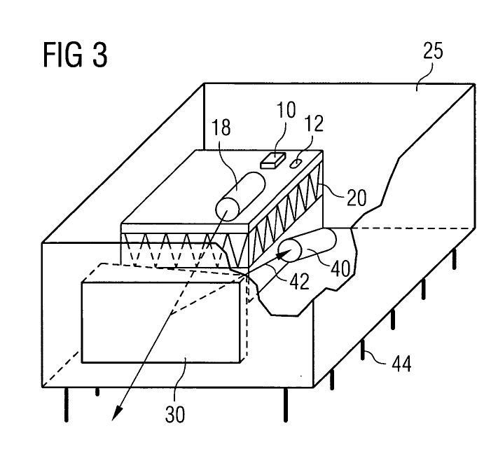

FIG. 3 shows a laser or light source according to another embodiment of the present invention.

The present invention employs a novel approach to packaging the light or laser source. The techniques used are similar to techniques employed in the telecommunications industry and provide an integrated approach that offers significant advantages over known techniques which involve assembling the required components individually into an instrument. The known techniques involve difficulties including those arising from moisture ingress and condensation.

FIG. 1 shows a light or laser source according to an embodiment of the present invention. Laser diode 10 is placed in thermal contact with a Peltier heat pump 20 and is provided with a drive current to produce laser light. A focusing lens 18 is provided to focus the light emitted from laser diode 10. A signal detector 22 is also provided, for detecting incident light. These elements are all encased within a housing 25. A window 30, transparent to the wavelengths emitted by laser diode 10, is provided in a part of the housing 25, to allow light from the laser diode to leave the housing, after passing through focusing lens 18, and to allow incident light to enter the housing to be detected by signal detector 22. The housing 25 is a hermetically sealed enclosure, preferably similar to those currently used in the telecommunication industry, and manufactured according to existing and established practices in that industry.

A temperature sensor 12 is provided, mounted on heat pump 20, preferably in the general vicinity of the laser diode 10. In certain embodiments of the invention, the temperature sensor is a platinum resistance thermometer, but other temperature sensitive devices of suitable size and sensitivity could be used. The temperature sensor provides an output signal to a temperature control means (not shown), to provide a primary feedback loop to control the heating or cooling of the laser diode by the heat pump. A secondary control may also be provided to “fine-tune” the temperature of the laser diode, as will be discussed below.

According to an aspect of the present invention, the use of hermetically sealed housing 25 provides the required resilience against the ingress of water, by the encapsulation of the necessary components: including the laser diode 10, the temperature-stabilising heat pump 20, and the signal detector 22. It is important that the housing contains no water when sealed. This may be achieved by filling the housing with a dry gas prior to sealing.

According to another aspect of the invention, the incorporation of a temperature stabilising element such as Peltier heat pump 20 provides precise temperature control and hence the required wavelength selection and stability.

Further means (not shown) are preferably also provided, to apply a predetermind drive current to the laser diode.

In order to detect the presence of a gas, light must be emitted having a wavelength corresponding to an absorption line of the spectrum of the gas to be detected. If the gas is not present, the light emitted will not be absorbed, and may be reflected back into the housing 25 to be detected by detector 22. If the gas is present, a proportion of that light will be absorbed by the gas, and a correspondingly reduced proportion of the emitted light will be returned to the detector 22. Intermediate levels of the gas provide intermediate levels of light (I) to the detector 22, following the Beer-Lambert law I=IoExp(-sCd), where lo is the intensity of light before passage through the gas sample, C is the gas concentration, d is the path length through the gas and s is the absorption constant for the gas.

The integrated light or laser source of the present invention is suitable for incorporation into a gas monitor product for use in telecommunications equipment. For the successful manufacture of a gas monitor product, the output wavelength of the laser diode 10 must be precisely controlled to coincide with an absorption line of the spectrum of a target (measured) gas. The laser diode 10 must therefore be temperature stabilised very precisely (typically to 0.1° C.). In the illustrated embodiment of the present invention, thermal control of the laser diode is achieved by use of a Peltier heat pump 20 that can be used to either cool or heat the laser diode 10 as required, depending on an ambient temperature.

FIG. 2 shows a second embodiment of the present invention in which a monitor detector 40 is provided within the housing 25. Features corresponding to those discussed with reference to FIG. 1 carry corresponding reference numerals. The output of this detector provides a means to positively and reliably identify the operating wavelength of the laser which can be controlled in accordance with the output of monitor detector 40, by varying the operating temperature of the laser diode 10, or the drive current applied, or both, whereby precise control of the laser wavelength can be produced. This enables a more stable wavelength to be produced than would be possible with the embodiment of FIG. 1.

In operation, the laser diode 10 provides light which is focused through lens 18 and transmitted out through the window 30. Because of a difference in refractive indices between the material of the window 30 and that of the ambient within the housing 25 a portion 42 of the light will be reflected back into the housing. This light may be received by monitor detector 40. The monitor detector may accordingly be used at least to determine that the laser diode or other light source is working, and to determine the intensity of light emitted. By providing monitor detector 40 with a sample of gas exhibiting narrow absorption lines consistent with the desired accuracy of wavelength stabilisation, the monitor detector 40 may provide feedback to help stabilise the wavelength provided by the laser diode 10 to the required value. The sample of gas may be a sample of the gas to be detected, depending on the nature of that gas. However, the gas to be detected may have a relatively broad spectral feature but possible interfering gases might have finer structure. In such a case the use of the monitored gas might not be suitable for wavelength stabilisation, and another gas should be employed, provided that gas exhibits narrow absorption lines consistent with the desired accuracy of wavelength stabilisation.

If the wavelength of light provided by the laser diode 10 is correctly adjusted, a proportion of the light 42 reflected from a surface of the window 30 will be absorbed by the gas sample, as the light 42 will have a wavelength corresponding to an absorption line of the spectrum of the gas concerned. If light 42 is not of the correct wavelength, it will not be absorbed to such an extent, and will not be absorbed before reaching a light sensor within the monitor detector 40. This may cause a signal to be sent to control circuitry (not shown) which causes the Peltier heat pump 20 to adjust the temperature of the laser diode to return the emitted light to the desired wavelength.

In an embodiment, monitor detector 40 comprises a light sensor, which may be in the form of an integrated circuit die, mounted within a sealed enclosure. Such monitor detector enclosure preferably contains a sample of a gas whose absorption line is to be used for tuning the wavelength emitted by the laser diode. Such gas is not necessarily the same as a gas which is to be detected by a gas detector incorporating the laser source, but such gas should be chosen to have an absorption line in the wavelength range of interest. The absorption line is preferably chosen to be as fine as possible.

In an alternative embodiment, the monitor detector 40 comprises a light sensor, which may be in the form of an integrated circuit die which is exposed to the interior of the hermetically sealed housing 25. The volume inside the package may be filled with a gas whose absorption line is to be used for tuning the wavelength emitted by the laser diode. Such gas is not necessarily the same as a gas which is to be detected by a gas detector incorporating the laser source, but such gas should be chosen to have an absorption line in the wavelength range of interest. The absorption line is preferably chosen to be as fine as possible.

Primary tuning of the laser diode is achieved by changing the temperature of the diode according to the information derived from the temperature monitor 12 within the package. This is sufficient to allow the wavelength emitted by the laser diode to be ‘tuned’ to the vicinity of an absorption line. While temperature monitor 12 provides information for primary temperature control, the monitor detector 40 monitors the accuracy of the wavelength emitted by the diode very precisely, by comparison with an absorption line of a reference gas. The monitor detector 40 may comprise a light sensor exposed to the interior of the housing 25. The monitor may alternatively comprise a transparent enclosure, itself containing a light sensor, the enclosure being mounted within housing 25. A sample of the reference gas is preferably included within the housing 25. Alternatively, or in addition, a sample of the reference gas may be placed within the enclosure of the monitor detector. The very precise signals correspondingly generated by the monitor detector 40 are used to exert fine control over the heat pump 20 to achieve the required temperature stability. This is the secondary or “fine tune” control of the heat pump.

Secondary tuning is preferably performed to further fine-tune the wavelength emitted by the laser diode. This may be achieved by further controlling the temperature of the laser diode, again using the heat pump but controlling it in accordance with information derived from the monitor detector 40.

In alternative embodiments, the secondary tuning may be performed by adjusting the electrical current used to drive the laser diode, which will adjust the output wavelength to a certain extent. This provides shorter-range and much faster control than the secondary tuning by temperature control as discussed above, and enables perturbations to be minimised on a shorter time-scale. This current-dependent-wavelength property of the laser diode may be utilised to stabilise the output wavelength, or alternatively to facilitate a particular type of measurement which requires a precise scan of wavelengths over a short range. It would also be possible to use the current dependency of the wavelength to directly control the output to provide a particular wavelength if this were required. This method of tuning the laser, while offering a much narrower tuning range than is achievable by temperature tuning, does offer much faster tuning, and so provides the potential for more precisely stabilised output wavelength. For example, a current-controlled wavelength adjustment may be carried out in several microseconds, whereas a temperature controlled wavelength change may take several milliseconds.

In further embodiments, the secondary tuning may be achieved by a combination of controlling the temperature of the laser diode and by controlling the current through it. For example, in order to produce a desired wavelength, the heat pump 20 may be controlled to heat the laser diode 10 to a corresponding temperature T as indicated on the datasheet of the laser diode 10, and as measured by temperature sensor 12. The laser diode will be supplied with a nominal current such as 100 mA, and a wavelength in the vicinity of the required wavelength will be produced. The current supplied to the laser diode may then be scanned , for example, between 50 mA and 150 mA while the monitor detector 40 monitors the resulting wavelength. The required wavelength may be achieved, for example, at a current of 145 mA. The laser diode may then be operated at the temperature T and a current of 145 mA. This will provide the required wavelength, but will consume excess power, and will only leave 5 mA of drive current available to compensate future drift in the wavelength produced. Preferably, the heat pump is then controlled to heat or cool the laser diode as appropriate, with the current supplied to the laser diode being correspondingly reduced until it returns to the nominal value (in this example, 100 mA), with the laser diode operating at a different temperature, T+δT. Such compound secondary tuning has the advantage that current control may be used for fast response and to maintain constant wavelength even through short term fluctuations, while temperature control allows wider overall range of wavelengths and can re-centre the range of current control to ensure that current control is always available.

In another example, current controlled secondary tuning may be employed to ‘scan’ the laser diode output wavelength across the gas absorption line(s) of interest. As described above, a required nominal wavelength may be achieved by (i) primary tuning by heating or cooling the laser diode to a temperature as indicated on the laser diode datasheet; (ii) secondary tuning the wavelength by controlling the current supplied to the laser diode; and (iii) adjusting the temperature of the laser diode and re-centring the current control. The current control may then be employed to scan over a range of wavelengths, for example, but not necessarily, centred on the nominal wavelength by varying the current supplied to the laser diode.

Such embodiments are particularly useful in gas detector applications. The laser source of the present invention may incorporate a reference gas sample, either within a sealed monitor detector package within the package 25, or filling substantially the entire cavity within package 25. The laser source may be controlled as discussed above to provide a wavelength corresponding to an absorption line of the reference gas. The current control can then be varied to scan over a range of different wavelengths, allowing the monitor detector to detect the presence of any further absorption lines within the scanned range of wavelengths, for example, those due to the presence of a measured gas.

The wavelength reference provided by this module is very precise and reliable. Stability of the order of 0.01 nm is achieved at an operating wavelength of approximately 1680 nm.

FIG. 3 shows a further embodiment of the present invention which may be used as a wavelength-stabilised light source for any application. Features corresponding to those discussed with reference to FIG. 1 or FIG. 2 carry corresponding reference numerals. As discussed with reference to FIG. 2, a portion 42 of the light emitted by laser diode 10 through focusing lens 18 is reflected from a surface of the window 30. This portion 42 is received by monitor detector 40, which contains a light detecting element. A sample of a reference gas is provided, within the monitor detector and/or filling the cavity within the housing 25. The detecting element may be used as discussed with reference to FIG. 2 in order to adjust the wavelength of the light provided by laser diode 10 to correspond to an absorption line of the spectrum of the gas sample. By controlling the heat pump 20, the output wavelength from laser diode 10 may be very accurately controlled, providing a light source of very stable wavelength. Such source may find applications in gas detectors and communications equipment, for example.

The laser or light sources according to the present invention, as described, are mounted in a hermetically sealed enclosure, similar to housings commonly used in the telecommunications industry. The housing ensures that the devices are kept clean and dry which is vital for reliable operation (especially when the Peltier is actively cooling the package below ambient temperature). The housing may be evacuated, or may be filled with a dry inert gas which has no spectral absorption lines in the wavelength range of operation. The various components within the housing need to be kept thermally isolated from one another, and a vacuum or a dry gas is preferably used to fill the housing although a transparent liquid or solid could be used, preferably one with a low thermal conductivity.

In each embodiment, pins 44 allow external connections to be made to the Peltier heat pump, the laser diode, the detectors and/or any other apparatus within the housing 25. For example, control circuitry required to control the heat pump may be external to the housing, but connected to the heat pump via pins 44. Alternatively, the control circuitry may be located within the housing 25, in which case only supply voltages may need to be applied via pins 44.

The integrated laser source according to the invention allows the laser to be used for any application where a precise wavelength control is required. Possible applications areas may include the telecommunication industry, for example, in the domain of fibre optic transmissions using wavelength division multiplexing. No special precautions need to be made in housing or mounting the module and there is no further requirement to provide moisture protection to protect the internal components.

Two possible applications of the present invention will now be briefly discussed.

In the field of communications, the wavelength stabilised laser source of the present invention may be used to provide a stable wavelength, for reference or for communication. Primary control of the wavelength of the emitted light may be exercised according to the temperature sensor 12. Secondary control may be exercised by adjusting the drive current applied to the laser diode according to the output of the monitor detector, in order to maintain a fixed wavelength output. The temperature of the laser diode may be adjusted to reduce the level of current control, or the current control alone may be used as secondary tuning. The use of current control allows fast reaction to any drift in the output wavelength, minimising any drift from the required wavelength. The drive current may be switched on and off to provide a communications signalling function. Secondary tuning is preferably not provided by temperature alone, as the reaction time may be too slow to provide the required accuracy in wavelength.

In the field of gas measurement, Primary control of the wavelength of the emitted light may be exercised according to the temperature sensor 12. Secondary control may be exercised by adjusting the temperature of the laser diode according to the output of the monitor detector. For example, a required wavelength may be obtained by primary control of the temperature of the laser diode, with secondary control initially being provided by controlling the current through the laser diode. The temperature may then be adjusted to allow the drive current to return to its nominal value. The required wavelength is then provided by suitable selection of the operating temperature of the laser diode. The drive current may then be adjusted to provide a wavelength offset from the required value. For example, this could be to detect an absorption line other than the absorption line used by the monitor detector. This may be an absorption line of a gas other than the reference gas. The drive current may be progressively adjusted to provide a “sweep” in wavelength across a certain range in the general vicinity of the required wavelength. Measurements of the intensity of light received in the sensor 22 are taken, and correlated against the wavelength emitted at that time. By taking a sequence of measurements of intensity readings against wavelength, a shape of an absorption line in a monitored gas may be measured, allowing the density and presence of a corresponding gas to be identified. By providing sufficient coverage in the wavelength sweep, the presence of two or more gases can be detected, for example, methane and ethane. The wavelength produced by the laser diode should be periodically returned to the required value, to check the accuracy of the wavelength produced, and to allow the operating temperature of the laser diode to be adjusted if necessary.

The present invention has been described with reference to a limited number of specific embodiments, given by way of examples only. However, numerous modifications and alternatives will be apparent to those skilled in the art. For example, although Peltier heat pumps have been discussed, alternative means for heating or cooling the laser diode may be provided. Furthermore, the relative location of the various components is not important, and the various components may be moved from their relative locations illustrated in the drawings, without departing from the scope of the present invention. Sources of light other than laser diodes may also be used, although laser diodes are presently preferred due to their small size and relative ease of manufacture.

In alternative embodiments of the invention, the gas sample may substantially fill the package, rather than, or in addition to, being encased within the monitor detector. This would result in a simpler construction, but may have a slight interfering effect, for example in gas measurement applications. If such a small interference was unimportant for a particular application then it would have two possible advantages in using such alternative embodiments. The construction cost would be reduced as there would be no need to separately encapsulate the monitor detector. In addition, a larger reference gas signal may be obtained because the optical path length through the gas sample within the package can be longer than could be achieved if the reference gas were only present within the monitor detector.

In further alternative embodiments, a laser diode may be used which is active in two directions. Light emitted in one direction may be directed through the window 30, while light emitted in the other direction may be directed onto a monitor detector. In such embodiments, the monitor detector could be placed behind the laser diode, as it will not be necessary to obtain a reflection from the window. An antireflective coating may then be applied to at least one surface of the window in order to reduce reflections of the emitted light, thereby reducing any interference effects caused by the passage of the light through the window.

1. An integrated wavelength-stabilised laser source comprising:
a laser diode (10);
a temperature-stabilising heat pump (20) in thermal communication with the laser diode; and
at least one detector (22; 40),
encapsulated within a hermetically sealed package (25) comprising a window (30) for passing light from the laser diode to the exterior of the package.

2. A source according to claim 1 wherein the heat pump is operable to adjust the operating temperature of the laser diode, thereby adjusting the wavelength of light emitted by the laser diode.

3. A source according to any preceding claim, further comprising a temperature sensor (12) arranged to provide primary control of the operation of the heat pump.

4. A source according to any preceding claim wherein the at least one detector comprises a monitor detector (40), positioned to receive a portion (42) of laser light emitted by the laser diode.

5. A source according to claim 4 wherein a surface of the window is arranged to reflect the portion of light emitted by the laser diode to the monitor detector.

6. A source according to claim 4 or claim 5 wherein the monitor detector is arranged to provide a control signal for controlling the wavelength of light produced by the laser diode.

7. A source according to any of claims 4-6, wherein the hermetically sealed package contains a gas sample, said gas having an absorption line for use by the monitor detector for measuring the wavelength of light emitted by the laser diode.

8. A source according to claim 7 wherein the interior of the hermetically sealed package is substantially filled with a gas sample.

9. A source according to any of claims 4-8 wherein the monitor detector comprises a light sensor exposed to the interior of the hermetically sealed package (25).

10. A source according to any of claims 4-8 wherein the monitor detector comprises a light sensor and a gas sample, enclosed within an enclosure.

11. A source according to any of claims 6-10 wherein the control signal from the monitor detector is arranged to control the operation of the heat pump, thereby adjusting the wavelength of light emitted by the laser diode by adjusting the operating temperature of the laser diode.

12. A source according to any of claims 6-11 wherein the control signal from the monitor detector is arranged to control a level of an operating current supplied to the laser diode, thereby adjusting the wavelength of light emitted by the laser diode.

13. A source according to claim 3 and claim 4 and any of claims 6-12 wherein secondary control of the heat pump is provided in accordance with an output of the monitor detector.

14. A source according to any preceding claim wherein the at least one detector comprises a detector (22) arranged to monitor incident light entering the package through the window.

15. A gas monitor product incorporating a source according to any proceeding claim.

16. A gas monitor product according to claim 15 and claim 7, wherein the gas sample corresponds to a gas to be monitored by the gas monitor product.

17. A gas monitor product according to any of claims 15-16, in conjunction with claim 14, arranged such that laser light may be emitted from the source to follow an optical path through a monitored gas, said optical path returning through the window to the detector, whereby absorption of the laser light may be evaluated in order to monitor the composition of the monitored gas.

18. A wavelength reference device comprising a source according to any of claims 1-14.

19. An integrated, wavelength-stabilised laser source substantially as described and/or as illustrated in the accompanying drawings.
